(19) United States
(12) Patent Application Publication
(10) Pub. No.: US 2013/0092487 A1
(43) Pub. Date: Apr. 18, 2013

(54) HYDRAULICALLY DAMPING BEARING

(71) Applicants: Andreas Erl, Hennigsdorf (DE); Ruediger Hack, Berlin (DE); Fabian Selent, Hennigsdorf (DE)

(72) Inventors: Andreas Erl, Hennigsdorf (DE); Ruediger Hack, Berlin (DE); Fabian Selent, Hennigsdorf (DE)

(73) Assignee: CARL FREUDENBERG KG, Weinheim (DE)

(21) Appl. No.: 13/643,298

(22) PCT Filed: Mar. 25, 2011
(86) PCT No.: PCT/EP11/01507

§ 371 Date: Dec. 20, 2012

(30) Foreign Application Priority Data
Apr. 30, 2010 (EP) 10 004 549.1

(51) Int. Cl. F16F 9/10

(52) U.S. Cl. CPC F16F 9/10
USPC 188/322.5

(57) ABSTRACT

A hydraulically damping bearing includes a damping fluid having a complex viscosity that is above the complex viscosity of polydimethyl siloxane within a first frequency range in which the damping fluid is excited upon the bearing being activated. The complex velocity of the damping fluid is below the complex viscosity of polydimethyl siloxane within a second frequency range in which the damping fluid is excited upon the bearing being activated.

### CROSS-REFERENCE TO PRIOR APPLICATIONS

This application is a U.S. National Phase application under 35 U.S.C. §371 of International Application No. PCT/EP2011/001507, filed on Mar. 25, 2011, and claims benefit to European Patent Application No. EP 10 004 549.1, filed on Apr. 30, 2010. The International Application was published in German on Nov. 3, 2011 as WO 2011/134578 under PCT Article 21(2).

### FIELD

The present invention relates to a hydraulically damping bearing.

### BACKGROUND

Hydraulically damping bearings are employed in order to provide insulation or damping against vibrations as well as to reduce noise pollution. Typical application cases are the bearings for passenger compartments, engines, transmissions, general machinery, aggregates and devices.

The single-mass oscillator having one degree of freedom is a model for handling technical tasks while optimally selecting a bearing for a concrete application case. Reference will be made time and again to this model.

In this context, the conflicting goals associated with a bearing can be expressed very clearly on the basis of the path-magnification function of the single-mass oscillator during the path excitation at the support and on the basis of the path magnification at the supported mass.

During periodical excitation, the ratio of the excitation frequency to the natural frequency can be divided into ranges on the basis of the magnification function.

If the frequency ratio is smaller than the square root of 2 (√2), then the path amplitude at the mass is equal to or larger than the excitation amplitude at the support; see FIG. 1. At a frequency ratio greater than √2, a path amplitude at the mass can be observed that is smaller than the excitation amplitude.

In actual practice, efforts are aimed at achieving harmonization ratios of the excitation frequency to the natural frequency that are greater than 2, better approximately 3 and larger. This often allows the path amplitude at the mass to be adequately diminished with respect to the excitation amplitude.

If a path excursion in the form of a square wave pulse is undertaken at the support, this gives rise to a vibration of the mass within the natural frequency of the single-mass oscillator. As the degree of damping increases in the corresponding magnification function of the single-mass oscillator during support excitation, the excessive rise in the path amplitude at the mass diminishes.

A first conflicting goal arises, for instance, if periodical excitations occur at the support in a vibration bearing, or if instead, pulse-like path excursions (for example, a square wave pulse) occur. This conflict lies in the fact that a high degree of damping with a pulse-like path excitation leads to a slight magnification in the response amplitude of the vibrating mass but, at the same time, with an otherwise favorable selection of the harmonization ratio of the natural frequency to the excitation frequency, this leads to a larger path amplitude at the supported mass during periodical excitation. This can be countered with a bearing that displays frequency-dependent damping behavior.

There is another conflicting goal aside from the one mentioned above. It consists of the different requirements that are made of the bearing element as well as of the bearing in the case of large-amplitude vibrations of the supported mass in contrast to the structural-elastic vibrations of parts of the supported mass, of the bearing, as well as of the support relative to other parts of the same objects or of the other objects that are operatively joined with them in the bearing.

Concretely speaking, when it comes to a bearing for a passenger compartment, the aim is to limit conceivably large amplitudes of the compartment with respect to the frame by means of the bearing element that establishes the connection. For this purpose, damping should be selected that is adapted to the compartment mass that is capable of vibrating. Criteria for this ensue from the relationships, namely, that the damping constant is proportional to the square root of the mass but, at the same time, that the natural angular frequency of the single-mass oscillator is proportional to the square root of the reciprocal value of the mass. This holds true for a constant stiffness in the frequency range under consideration.

At the same time, the phenomenon exists that, in actual practice, the supported mass, the bearing as well as the support are capable of structural-elastic vibrations. As a rule, such vibrations, after being commensurately excited, give rise to an appreciable emission of noise. Noise issuing forth from the bearing as well as from the supported mass is often a disturbing factor.

In the case of such vibrations, only a portion of the involved mass is to be ascribed to the total mass of the objects that are operatively joined in the bearing. The vibration amplitudes of structural-elastic vibrations are smaller by several orders of magnitude than those, for example, of a passenger compartment as a rigid body in the compartment bearing under consideration here. This is the reason for the desire for damping that is adapted to this scenario.

Here, the term large-amplitude path excursions at the support refers to those that lead to a movement of the entire mass relative to the support, in contrast to which small-amplitude path excursions are those that cause, for instance, only parts of the passenger compartment to move relative to other parts of the compartment, namely, the structural-elastic vibrations. The transition here is fluid. For this reason, the damping that is to be selected should not take on values that differ abruptly.

If a mass is no longer considered as being punctiform, but rather as extending spatially and as being supported on several bearing elements, then several degrees of freedom should be employed. Then, depending on the bearing, on the bearing elements and on the excitations, one can see resonant amplitude magnifications in the appertaining motion coordinates that are below, within or even above the natural deviation frequency of the supported mass. This gives rise to another conflicting goal in selecting the appropriate damping and the stiffness of the spring of the bearing element. The example shown here is a passenger compartment supported on four bearing elements against the frame of a given vehicle. This applies at a constant stiffness over the frequency range under consideration.

The ideal single-mass oscillator having one degree of freedom, having a massless spring and having a constant damping is well-suited in actual practice for the approximated handling of so-called rigid-body vibrations. In a first approximation, a single-mass oscillator having one degree of freedom, having a spring with mass and having a constant damping can deal with the structural-elastic vibrations. Here, the introduced magnification function displays secondary maxima at higher frequencies than the one natural frequency in the case of a massless spring.

According to the notion of the structural-elastic vibrations, the parts of the volume of a component of an elastic, extended body with mass move with respect to adjacent parts of the same component. The same holds true accordingly for adjacent partial surfaces of the entire surface of a component that is to be observed.

Here, a distinction should be made if, on the basis of these multifaceted measurable effects and relationships, conclusions are to be drawn about the requirements made of the bearing. For this purpose, knowledge about the excessive rise in the vibration amplitude at the upper bearing and/or at the lower bearing of the bearing is to be utilized.

Fundamentally, the entire course of the vibration amplitude measured at the upper bearing or at the lower bearing over the excitation frequency can be dealt with quite well by representative single-mass oscillators if there are clearly pronounced maxima that are at a distance from each other. This is particularly the case with small degrees of damping.

If the objective is to reduce these maximum deflections, knowledge about the single-mass oscillator having one degree of freedom and a massless spring can be employed accordingly and, for example, the damping can be increased, provided that a bearing element can be configured in accordance with these maxima and the associated goals with an eye towards meeting the requirements.

It is not always possible to adapt the harmonization ratio of the natural frequency to the excitation frequency in the motion coordinates so as achieve a ratio greater than 2, better approximately 3, for all natural frequencies, nor to make a damping selection that allows the best insulation.

If the damping constant is constant over the entire frequency range of the ascertainable magnification function, the result is a comprehensive conflicting goal in the handling of the single-mass oscillator when the support is excited by means of path excursion with pulse-like excitations or periodical excitations at a smaller or larger path excursion.

As a compromise, it is here often only possible to select the appropriate damping. From the theory of single-mass oscillators, as has been widely shown in the literature, it can be derived that the degrees of damping should then not be selected at random. The recommended degrees of damping to be selected are D= . . . 0.2 . . . 0.5 . . . .

It is possible to deviate from this in actual practice if the bearing element cannot be made to correspond to the ideal single-mass oscillator with a sufficient level of precision.

In many practical cases, the known recommendations, however, are applicable without reservation.

In order to design a bearing element, its properties should be expressed in reproducible relationships between excitation and response. Calculations and measurements in a motion coordinate are often employed for this purpose. In the concept phase, it is absolutely necessary to turn to qualitative relationships among various physical conditions.

Furthermore, it turns out that, in order to solve the conflicting goals that are to be dealt with in determining the properties of the bearing element, a distinction should be made between the dependence on the excitation amplitude and on the excitation frequency.

In a first step, it is completely sufficient to determine the bearing properties up to a frequency that reaches at least the highest rigid-body frequency in the bearing.

To an increasing degree, however, it is also relevant to take the noise emission in a bearing into consideration. For this purpose, the structural-elastic vibrations of the bearing also have to be included in the design of the bearing element. If partial surfaces of individual components of the bearing element that move relative to each other during these vibrations of the bearing are in direct contact with the fluid volumes inside the bearing and if this movement gives rise to a volume flow involving losses, then the path amplitude of this relative movement can be reduced. This is of particular interest for the geometry of the elastomer that joins the upper bearing to the lower bearing. As an indirect consequence, this has a favorable effect on the possible noise emission, for example, in the passenger compartment of a vehicle.

Based on these preliminary considerations, the bearing element used in an embodiment of the present invention was designed based on German utility model DE 2006 021 498 U1, the entire contents of which is hereby incorporated by reference herein, but, for the sake of brevity, will only be presented below in the form of excerpts.

It already partially solves the above-mentioned comprehensive conflicting goal and it is shown in FIG. 2.

The bearing 10 has an upper bearing 11 to which the mass that is to be supported has to be attached. The upper bearing 11 is joined to a lower bearing 13 by a spring element 12.

The bearing 10 also has a space 14 that is filled with a damping fluid 15. A disk 13 that interacts with the damping fluid 15 when the bearing 10 is actuated is installed on the upper bearing 11. Part of the space filled with the damping fluid 15 is delimited by an elastic membrane 16.

The damping fluid 15 is typically polydimethyl siloxane (silicone oil) whose viscosity changes as a function of the excitation frequency.

### SUMMARY

In an embodiment the present invention provides a hydraulically damping bearing. The bearing includes a damping fluid having a complex viscosity that is above the complex viscosity of polydimethyl siloxane within a first frequency range in which the damping fluid is excited upon the bearing being activated. The complex velocity of the damping fluid is below the complex viscosity of polydimethyl siloxane within a second frequency range in which the damping fluid is excited upon the bearing being activated.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a diagram depicting the curve of the ratios of the path amplitude to the excitation amplitude as a function of the frequency for various degrees of damping D for the known single-mass oscillator model;

FIG. 2 is a section through a known hydraulic bearing; and

FIG. 3 is a diagram depicting the curve of the complex viscosity for pure polydimethyl siloxane B and for the damping fluid A according to an embodiment of the invention, as a function of the excitation frequency according to an embodiment of the present invention.

### DETAILED DESCRIPTION

In order for the hydraulically damping bearing to attain important properties in terms of its vibration behavior, relative movements of the upper bearing vis-à-vis the lower bearing are designed to lead to a volume flow involving losses inside the bearing—while interacting with the membrane and the elastomer that joins the upper bearing to the lower bearing.

In actual practice, however, it has been found according to an embodiment of the invention that the viscosity of polydimethyl siloxane at frequency ratios of less than √2 in the single-mass oscillator is too low in some applications, and it should be less at frequency ratios of more than √2 in the single-mass oscillator.

In an embodiment, the invention provides a hydraulically damping bearing that overcomes the above-mentioned drawbacks. The bearing displays improved damping and vibration properties. In particular, an embodiment of the invention provides a damping fluid that can be qualitatively harmonized with the specific damping work of the bearing.

According to an embodiment, the hydraulically damping bearing comprises a damping fluid that has a complex viscosity that is above the complex viscosity of polydimethyl siloxane when within a first frequency range in which the damping fluid is excited when the bearing is activated, and that is below the complex viscosity of polydimethyl siloxane when within a second frequency range in which the damping fluid is excited when the bearing is activated.

The complex viscosity is ascertained here by means of a rheometer in accordance with DIN 53019. In the rheometer, at a defined gap width, a conical form is periodically turned against a plate, with fluid being present in-between. During the measurement, the amplitude of the periodical rotational movement is kept constant. The measurement is carried out isothermically.

Under standard conditions (20° C. [68° F.]), the polydimethyl siloxane preferably has a viscosity of about 100,000 mPas at a number of approximately 1392 links.

The evaluation of the measured results revealed that it should be possible to describe the complex viscosity of the damping fluid with sufficient precision for actual-practice cases by means of the equation below:

$$η ( f ) = \frac{a}{{( 1 + b \cdot f )}^{c}} + \frac{{( 1 + d \cdot f )}^{e}}{g}$$

Based on the approximation formula for the complex viscosity given above, the following can be described in a double-logarithmic notation:
1) a range of constant complex viscosity, value a, starting at the excitation frequency of 0.01 Hz;
2) followed by a second range of less complex viscosity, value smaller than a, with a pronounced minimum;
3) followed by a range in which the complex viscosity has a value that is above the value of the complex viscosity of the first range, value greater than a, up to the excitation frequency of 100 Hz.

According to the cited considerations, a hydraulically damping bearing is designed in accordance with an embodiment of the invention based on German utility model DE 2006 021 498 U1 which, however, in an embodiment of the invention uses a damping fluid that is not pure polydimethyl siloxane, but rather, has admixtures, or that is even a completely different fluid. If the damping fluid consists of polydimethyl siloxane with admixtures, the polydimethyl siloxane can have, for instance, at least 1000, more preferably at least 1300, links.

The damping fluid is characterized, in an embodiment, by certain properties that can be expressed on the basis of the approximation formula given above. Thus, a ratio formed from the value a related to the value of the pronounced minimum in range 2) should be greater than in the case of pure polydimethyl siloxane, which has the same value a of the complex viscosity as the damping fluid that differs from it. In the case of pure polydimethyl siloxane with a complex viscosity that amounts to 100 Pas in the rheometer at small excitation frequencies (value a according to the approximation equation), the above-mentioned ratio concretely amounts to 1.7. Moreover, the pronounced minimum of the complex viscosity in range 2) should equal the value of the pronounced minimum of pure polydimethyl siloxane likewise in range 2), or preferably be smaller. It should be possible to find the above-mentioned minimum of the damping fluid at approximately the same frequency in the same measuring array (rheometer) under otherwise identical conditions, as is the case with pure polydimethyl siloxane.

According to the fundamental considerations elaborated upon above, such a damping fluid that differs from polydimethyl siloxane causes the specific damping work in the bearing at small amplitudes to be small or even smaller than in a bearing according to German utility model DE 2006 021 498 U1, with pure polydimethyl siloxane as the damping medium.

This is done in such a way that, at small excitation amplitudes and higher frequencies, less specific damping work occurs in the bearing under periodical excitation than with a polydimethyl siloxane, and consequently a lower resistance can be set against the relative movement between the upper bearing and the lower bearing, which can lead to better insulation. Conversely, the bearing refined according to the invention is capable of compensating for the associated drawbacks. Through the adaptation of the course of the complex viscosity of the novel damping fluid, according to the definition, the bearing can be better adapted to the requirements made by a concrete application. At the same time, at relative movements of a large amplitude and small excitation frequencies, a higher complex viscosity of the damping fluid according to the definition results in a higher degree of damping and thus a greater reduction of the response amplitude at a corresponding excitation in comparison to the bearing with pure polydimethyl siloxane.

Moreover, the damping fluid is characterized, in an embodiment, in that its properties can also be described by a complex shear modulus that consists of the addition of a loss portion and a storage portion. On the basis of the excitation frequency, which was determined at a constant amplitude in a rheometer, it is especially ascertained that, in terms of its value, the loss portion outweighs the storage portion for a long time, until finally the storage portion has a higher value. Preferably, this change is found at an excitation frequency between 10 Hz and 100 Hz. The complex viscosity and the complex shear modulus are especially in a relationship with each other that can be ascertained in terms of its value.

Favorable values for the constants from the approximation equation of the complex viscosity will be given in context below so that their advantages can be utilized.

Values for the constants:
a should amount to 30 Pas up to and including 4000 Pas
b should be greater than zero, preferably 0.01 up to and including 30
c should be equal to or greater than zero, preferably 0.1 up to and including 5
d should be greater than zero, preferably 1 up to and including 10
e should be greater than zero, preferably 0.01 up to and including 30
g should be greater than zero, preferably 0.1 up to and including 10

The ratio of the initial viscosity from range 1) relative to the minimum viscosity from range 2) should preferably be greater than or equal to 1.7 or preferably between 1.7 and 30. Moreover, the pronounced minimum of the complex viscosity in range 2) should be equal to the value of the pronounced minimum of the polydimethyl siloxane likewise in range 2), or preferably should be less.
Preferably, these minimum values should be selected so as to be smaller than or equal to 50 Pas, smaller than or equal to 70 Pas, smaller than or equal to 100 Pas.
It should be possible to find the above-mentioned minimum of the damping fluid approximately at the same frequency in the same measuring array (rheometer) under otherwise identical conditions, as is the case with pure polydimethyl siloxane.
Preferably, the minimum in a rheometer measurement at a constant excitation amplitude is found between 10 Hz and 100 Hz.
The range 1) of the complex viscosity is preferably found up to 0.1 Hz, or up to 1 Hz.
This information is based on knowledge about fluids that fall within this property definition.

In accordance with an embodiment of the bearing according to the invention, the second frequency range has a higher frequency value than the first frequency range.

In accordance with an embodiment of the bearing according to the invention, the first frequency range encompasses frequencies between 0 Hz and 10 Hz, while the second frequency range encompasses frequencies between 10 Hz and 70 Hz, especially greater than 10 Hz and smaller than 70 Hz.

In accordance with an embodiment of the bearing according to the invention, the damping fluid has a complex viscosity that is above the complex viscosity of polydimethyl siloxane when it is within a third frequency range in which the damping fluid is excited when the bearing is activated.

In accordance with an embodiment of the bearing according to the invention, the third frequency range has a higher frequency value than the second frequency range.

In accordance with an embodiment of the bearing according to the invention, the third frequency range encompasses frequencies greater than 70 Hz.

In accordance with an embodiment of the bearing according to the invention, the complex viscosity is greater than 100 Pas in the first frequency range, smaller than 100 Pas in the second frequency range and/or greater than 100 Pas in the third frequency range.

In accordance with an embodiment of the bearing according to the invention, several partial volumes are formed between which the damping fluid flows at varying velocities during the operation of the bearing.

In accordance with an embodiment of the bearing according to the invention, an upper bearing and a lower bearing are joined to each other by means of a spring element, whereby at least the spring element and a membrane delimit a space filled with the damping fluid.

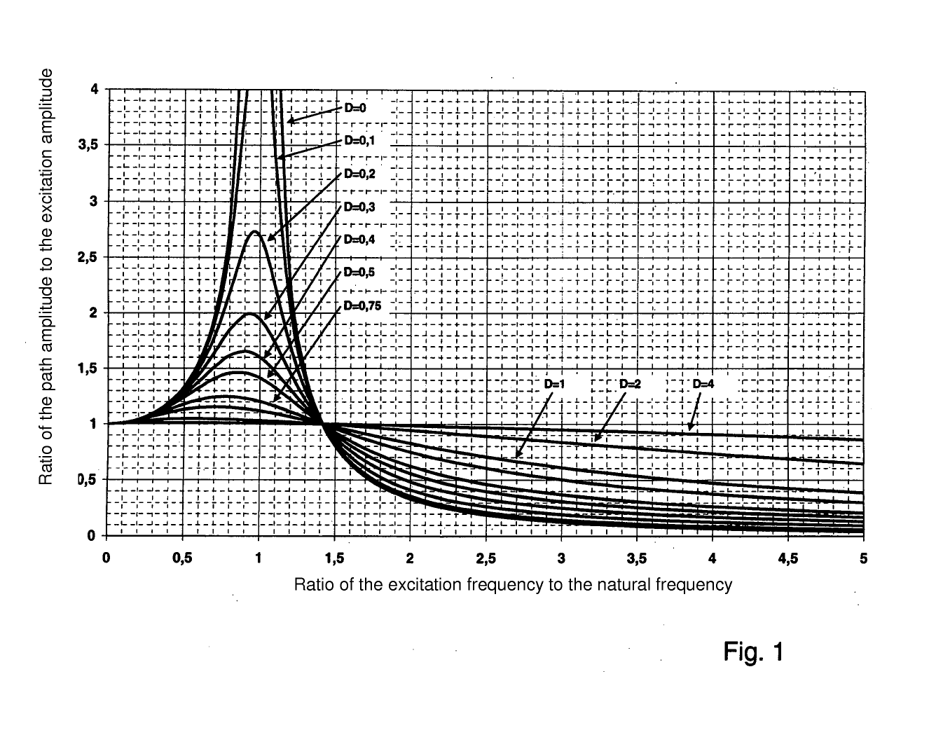

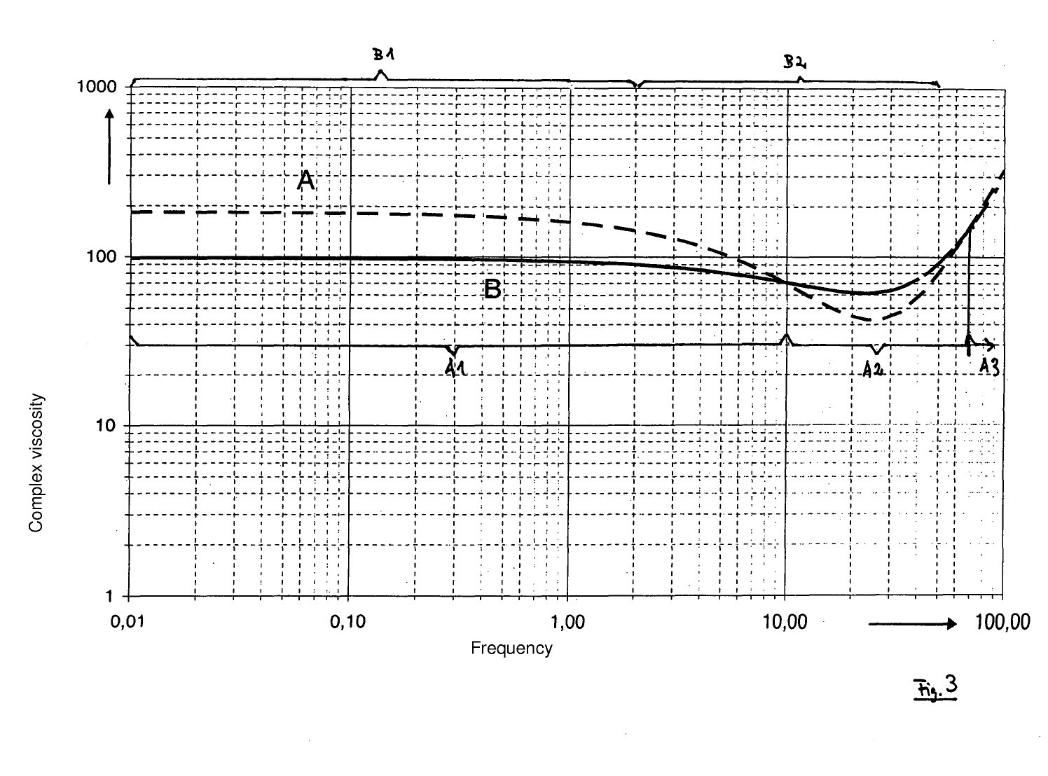

The curve of the viscosity for polydimethyl siloxane as a function of the excitation frequency is shown in FIG. 3 and designated with the reference numeral “B”. The curve shown in FIG. 3 was determined in a rheometer but it applies correspondingly to the use of pure polydimethyl siloxane in the bearing 10. The viscosity and a corresponding damping are high in a first frequency range B1. The natural frequency of the mass that is to be supported (single-mass oscillator model) should be in the first frequency range B1, so that a small path amplitude is achieved here, see FIG. 1. In a second frequency range B2, which is of a higher frequency value than the first frequency range B1, the viscosity of the polydimethyl siloxane and a corresponding degree of damping should be smaller than in the first frequency range B1. As a result, at frequency ratios above √2 (even in the presence of structural-elastic vibrations), it is likewise possible to achieve a reduction in the path amplitude.

The curve designated by the reference numeral B′ was measured on a bearing 10 with pure polydimethyl siloxane as the damping fluid.

As can be seen in curve A in FIG. 3, a damping fluid A for the bearing 10 according to the invention is defined in such a way that it has a complex viscosity in a first frequency range A1, said viscosity being above that of pure polydimethyl siloxane.

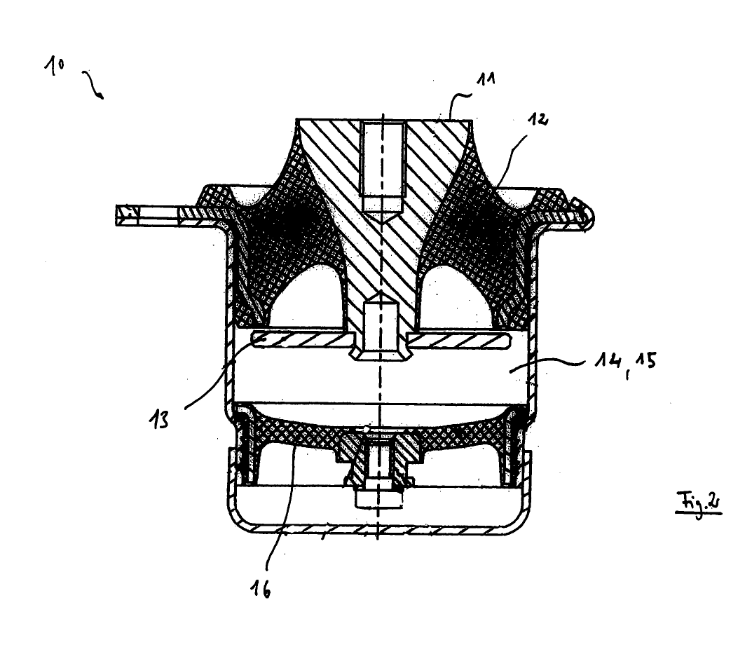

Consequently, when the damping fluid A is used in the bearing 10—see FIG. 2—this yields a high degree of damping at low excitation frequencies, which advantageously results in a small path amplitude. The term low excitation frequencies refers especially to those that yield a frequency ratio smaller than √2.

Moreover, in a second frequency range A2, the damping fluid A has a complex viscosity that is below that of polydimethyl siloxane. The second frequency range A2 extends, for example, from 10 Hz to 70 Hz. In the second frequency range, the damping fluid A has a viscosity, for instance, smaller than 100 Pas, preferably smaller than 70 Pas and even more preferably smaller than 50 Pas.

The curve A described above for the damping fluid A was determined by means of a rheometer, but it applies likewise when said fluid is employed as the damping fluid 15 for the bearing 10.

As a simplification, the frequency-dependent damping constant of the bearing can be seen as being proportional to the viscosity of the fluid multiplied by a reference length, corrected by additional influencing variables. These additional influencing variables especially refer to the temperature, the resilience of the bearing components that delimit the fluid volume, here particularly those made of elastomer, the division of the fluid volume into partial volumes through structural measures, the fluid density as well as the excitation amplitude.

Under dynamic actuation, adjacent volume areas of the fluid having different flow rates or frequencies (flow profile) are established in the bearing. This also depends on the hydraulic transmission ratio of the fluid-driving cross section as a function of the upper bearing, the elastomer element, the lower bearing and the cross section of the area through which fluid flows, for example, the gap between the displacement disk and the housing. This relationship can be found in several places in the bearing.

For this reason, there is an indirect relationship between the curve of the complex viscosity of fluid A, determined in the rheometer, and the curve of the specific damping work of the bearing between the upper bearing and the lower bearing when actuated in the longitudinal axis of the bearing. This relationship can be measured by technical means and, on this basis, also determined with suitable, adapted computation models. As a refinement of the insight gained, it is thus possible to derive a specification of the fluid that is harmonized with the requirements of a concrete application.

The fact that the specification can be implemented for actual fluids is to be found with or within the scope of the above-mentioned information regarding the constants of the approximation equation or of the ratio of the complex viscosity of range 1) to the minimum within range 2).

Below, the single-mass oscillator during harmonic force excitation at the mass when it is supported against a rigid fundament will be considered.

If the amplitude of the ground force in the presence of damping is related to the amplitude of the ground force in the absence of damping and plotted over the degree of damping at a constant ratio of the excitation frequency and the natural angular frequency of the single-mass oscillator, then the result is that, as the degree of damping increases, this ratio of the forces rises. This broadens the comprehensive conflicting goal if a bearing having the same property is supposed to be employed for cases pertaining to support excitation (path amplitude) aimed at a less excessive rise in the amplitude at the mass, and pertaining to force excitation at the supported mass aimed at less ground force. On the basis of this force ratio, it can be concluded that the degree of damping should be smaller than 1 so that acceptable ground-force amplitudes can be obtained. The statements made concerning the proportionalities of the damping constants and the natural angular frequency also hold true here.

The person skilled in the art is thus always in a position to produce the damping fluid A, provided that the parameters defined above are taken into consideration.

Naturally, the damping fluid A defined above can also be employed for a hydraulic bearing that has a construction that differs from that of the bearing 10. However, all of the hydraulic bearings for which the damping fluid A is suited have in common the fact that they entail the formation of several partial volumes between which the damping fluid A flows at different velocities during the operation of a given bearing.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1-12. (canceled)

13. A hydraulically damping bearing comprising:
a damping fluid having a complex viscosity that is above the complex viscosity of polydimethyl siloxane within a first frequency range in which the damping fluid is excited upon the bearing being activated, and that is below the complex viscosity of polydimethyl siloxane within a second frequency range in which the damping fluid is excited upon the bearing being activated.

14. The bearing according to claim 13, wherein the second frequency range has a higher frequency value than the first frequency range.

15. The bearing according to claim 13, wherein the first frequency range is between 0 Hz and 10 Hz and the second frequency range is between 10 Hz and 70 Hz.

16. The bearing according to claim 13, wherein the complex viscosity of the damping fluid is above the complex viscosity of polydimethylsiloxane within a third frequency range in which the damping fluid is excited upon the bearing being activated.

17. The bearing according to claim 16, wherein the third frequency range has a higher frequency value than the second frequency range.

18. The bearing according to claim 16, wherein the third frequency range is greater than 70 Hz.

19. The bearing according to claim 16, wherein the complex viscosity is greater than 100 Pas in the third frequency range

20. The bearing according to claim 13, wherein the complex viscosity is at least one of greater than 100 Pas in the first frequency range and smaller than 100 Pas in the second frequency range.

21. The bearing according to claim 13, wherein the complex viscosity of the damping fluid is represented in a double-logarithmic notation as:
a range of constant complex viscosity, value a, starting at an excitation frequency of 0.01 Hz, followed by a second range of less complex viscosity, value smaller than a, with a pronounced minimum, and then followed by a range of higher complex viscosity, value greater than a, up to the frequency of 100 Hz.

22. The bearing according to claim 13, wherein the complex viscosity η(f) is represented by the following equation:
$$η ( f ) = \frac{a}{{( 1 + b \cdot f )}^{e}} + \frac{{( 1 + d \cdot f )}^{e}}{g}$$
wherein a, b, c, d, e, and g are constants and f is the excitation frequency.

23. The bearing according to claim 22, wherein at least one of:
the constant a is between 30 Pas and 4000 Pas;
the constant b is greater than zero;
the constant c is equal to or greater than zero;
the constant d is greater than zero;
the constant e is greater than zero; and
the constant g is greater than zero.

24. The bearing according to claim 23, wherein at least one of:
the constant b is between 0.01 and 30;
the constant c is between 0.1 and 5;
the constant d is between 1 and 10;
the constant e is between 0.01 and 30; and
the constant g is between 0.1 and 10.

25. The bearing according to claim 13, further comprising a plurality of partial volumes formed in the bearing such that the damping fluid flows at varying velocities during the operation of the bearing.

26. The bearing according to claim 13, wherein the bearing includes an upper bearing and a lower bearing that are joined to each other by a spring element, at least the spring element and a membrane delimiting a space filled with the damping fluid.
